(19) United States
(12) Patent Application Publication
(10) Pub. No.: US 2014/0082238 A1
(43) Pub. Date: Mar. 20, 2014

(54) METHOD AND SYSTEM FOR IMPLEMENTING A CONTROL REGISTER ACCESS BUS

(71) Applicants: Sagheer Ahmad, Cupertino, CA (US); Michael P. Cornaby, Hillsboro, OR (US); Laurent Rene Moll, San Jose, CA (US); Jay Kishora Gupta, Milpitas, CA (US)

(72) Inventors: Sagheer Ahmad, Cupertino, CA (US); Michael P. Cornaby, Hillsboro, OR (US); Laurent Rene Moll, San Jose, CA (US); Jay Kishora Gupta, Milpitas, CA (US)

(73) Assignee: NVIDIA CORPORATION, Santa Clara, CA (US)

(21) Appl. No.: 13/619,780

(22) Filed: Sep. 14, 2012

(51) Int. Cl. G06F 13/42

(52) U.S. Cl. 710/110

(57) ABSTRACT

A communication system is described providing for access to registers over a control register access bus. The system includes one or more core units including one or more addressable core registers, wherein the units are coupled to the communication bus. The system also includes one or more core clusters (CCLUSTERs) coupled to the one or more core units through the communication bus. The CCLUSTERs provide one or more gateways for transactions to and from the one or more core units. The system also includes a request ordering and coherency (ROC) unit coupled to the CCLUSTERs through the communication bus that is configured for scheduling transactions relating to the registers onto the communication bus. The system also includes the one or more addressable registers that are located in the ROC unit, the CCLUSTERs, and the one or more core units.

### BACKGROUND

System-on-chip (SoC) performance depends upon the efficiency of its bus architecture, wherein the SoC integrates multiple components (e.g., embedded central processing units, system cores, peripheral cores, dedicated hardware, field programmable gate arrays, embedded memories, etc.) of an electronic system onto a single chip. A bus architecture allows for pipelined communication between these components.

In particular, a control bus is used by the components of a SoC to direct and monitor the actions of other functional areas of the overall computer. For instance, the bus is used by a component to transmit and receive transactions (e.g., read, write, interrupt, acknowledge, etc.) to coordinate management and control of a computer. More particularly, status and configuration information may be passed into and out of registers.

Heretofore, existing low-cost register access busses are either too slow (i.e. low throughput and high latency), or too inflexible for adapting to ring or tree or star topology, or not suitable for power-efficient chips (i.e. for chips with multiple on-die power-gated partitions which can be power gated independently).

When a system architecture includes thousands upon thousands of components, existing register access busses are unable to handle real time accesses to control registers. This becomes a problem when trying to implement power management within the system on a real-time basis. Increased latency in the implementation of power management to one or more components decreases the ability to implement and efficiency of the power management system.

Additionally, with many of these bus architectures, the bus protocols are synchronous and run at a particular clock frequency throughout the system. That is, these bus protocols are not equipped to handle other frequency uses without complicated solutions.

It is desirous to have a control access register bus that has a deterministic latency and high throughput where needed.

### SUMMARY

In embodiments of the present invention, a communication system for accessing control registers is disclosed. The system includes a communication bus configured for accessing control registers. The system also includes one or more core units including one or more addressable core register, wherein the units are coupled to the communication bus. The system also includes one or more core clusters (CCLUSTERs) coupled to the one or more core units through the communication bus. The CCLUSTERs provide one or more gateways for transactions to and from the one or more core units. The system also includes a request ordering and coherency (ROC) unit coupled to the CCLUSTERs through the communication bus that is configured for scheduling transactions relating to the registers onto the communication bus. The system also includes the one or more addressable registers that are located in the ROC unit, the CCLUSTERs, and the one or more core units.

In another embodiment, a method for implementing a communications system is disclosed. The method includes providing a communication bus that is configured for accessing control registers. The method includes coupling one or more core units including one or more addressable core registers onto the communication bus. The method also includes coupling one or more core clusters (CCLUSTERs) to the one or more core units through the communication bus. The one or more CCLUSTERs provide one or more gateways for transactions to and from the one or more core units. The method also includes coupling a request ordering and coherency (ROC) unit to the one or more CCLUSTERs through the communication bus, wherein the ROC unit is used for scheduling transactions relating to the registers onto the communication bus. The method also includes providing a plurality of addressable registers located in the ROC unit, the CCLUSTERs, and the one or more core units in various combinations.

In embodiments of the present invention, a communication system for accessing control registers is disclosed. The system includes a communication bus configured for accessing control registers with low latency and high throughput. The system includes a core unit including one or more slave components including one or more control registers. The core unit is coupled to the communication bus. The one or more slave components are configured in a ring topology. Each slave component provides a transaction interface to corresponding registers contained within the corresponding slave component. The system also includes a core-master for scheduling transactions related to the registers onto the ring topology of the communication bus.

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 depicts a block diagram of an exemplary computer system suitable for implementing the present methods, in accordance with one embodiment of the present disclosure.

FIG. 2A is a system implementing a control register access bus, in accordance with one embodiment of the present disclosure.

FIG. 2B is a flow diagram illustrating a method for implementing a control register access bus, in accordance with one embodiment of the present disclosure.

FIG. 3 is a block diagram of an exemplary system implementing a control register access bus configured in a mixed tree and ring topology, in accordance with one embodiment of the present disclosure.

FIG. 4 is a block diagram of a root-master configured to handle register transactions on the control register access bus, in accordance with one embodiment of the present disclosure.

FIG. 5 is a block diagram of an exemplary splitter used for distributing register transactions to multiple destinations, in accordance with one embodiment of the present disclosure.

FIG. 6 is a block diagram of an exemplary bridge defining a branch node, wherein a bridge provides clock and/or power gating for underlying branches, in accordance with one embodiment of the present disclosure.

FIG. 7 is a diagram illustrating a ring topology for a core unit located on a control register access bus, in accordance with one embodiment of the present disclosure.

FIG. 8A is a diagram illustrating a flow-controlled slave component that is used for uncore units accessible through a control register access, in accordance with one embodiment of the present disclosure.

FIG. 8B is a diagram illustrating a pipelined slave component accessible through a control register access bus that is used for ring topologies in the core and uncore units, in accordance with one embodiment of the present disclosure.

FIG. 9A is an illustration of a 32-bit WRITE pipeline, in accordance with one embodiment of the present disclosure.

FIG. 9B is an illustration of a 64-bit WRITE pipeline, in accordance with one embodiment of the present disclosure.

FIG. 10A is an illustration of a 32-bit READ pipeline, in accordance with one embodiment of the present disclosure.

FIG. 10B is an illustration of a 64-bit READ pipeline, in accordance with one embodiment of the present disclosure.

FIG. 11A is an illustration of a 32-bit paired READ pipeline, in accordance with one embodiment of the present disclosure.

FIG. 11B is an illustration of a 32-bit WRITE followed by a 32-bit READ pipeline, in accordance with one embodiment of the present disclosure.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

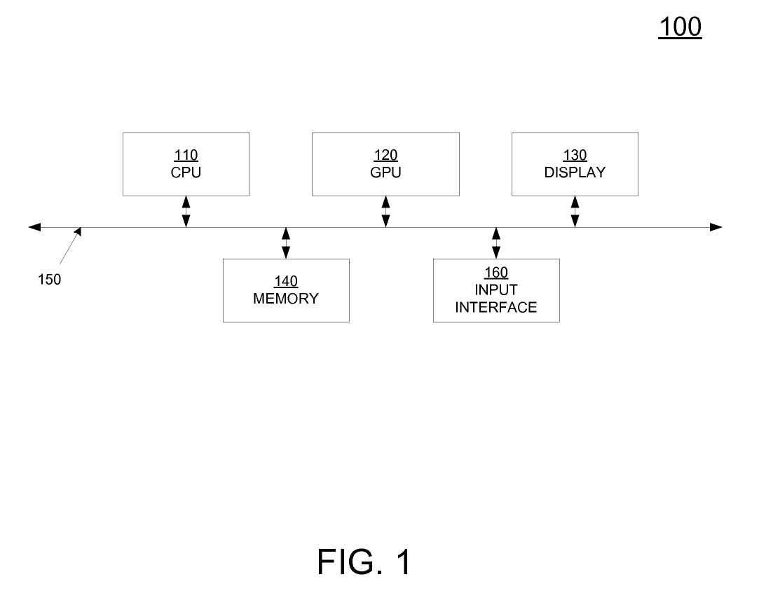

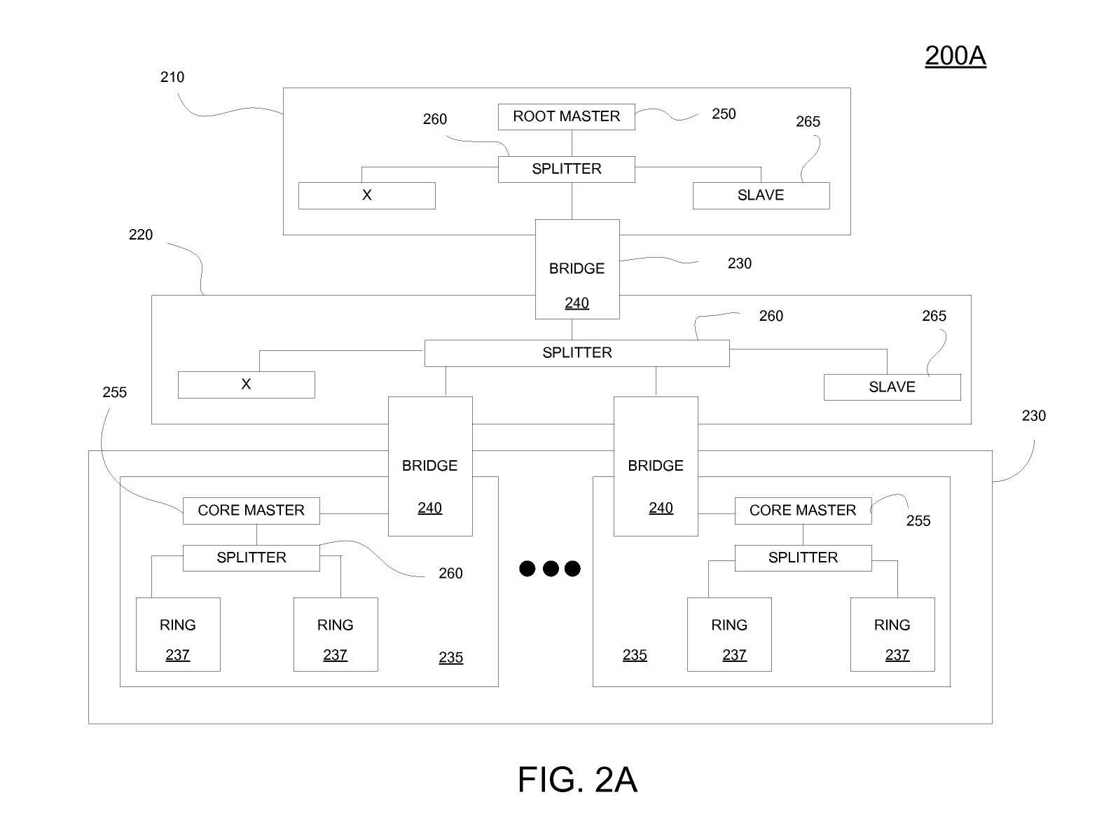

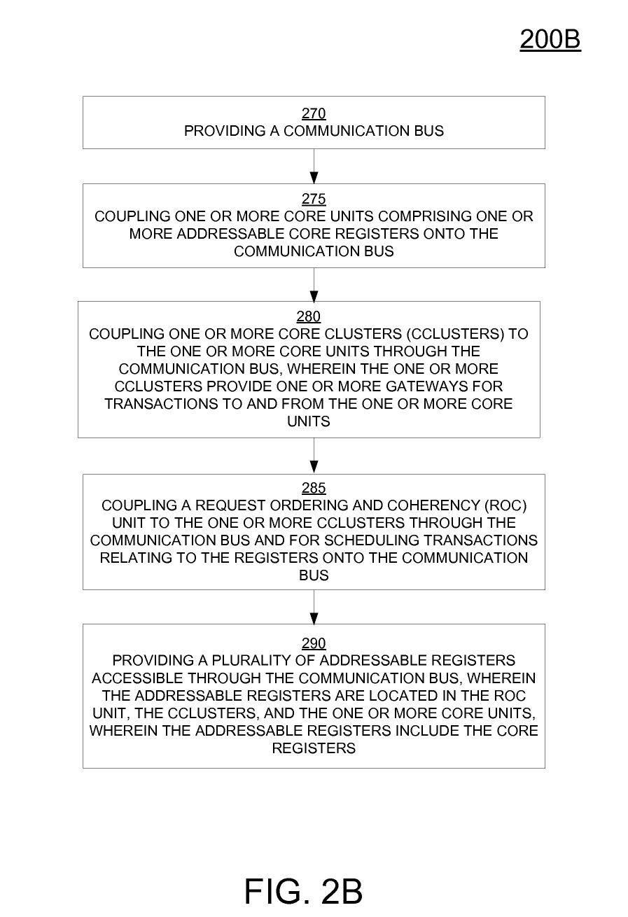

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “providing,” “executing,” “configuring,” “handling,” or the like, refer to actions and processes (e.g., flowcharts 200 of FIG. 2) of a computer system or similar electronic computing device or processor (e.g., system 100 of FIG. 1). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

FIG. 1 is a block diagram of an example of a computing system 100 capable of implementing embodiments of the present disclosure. Computing system 100 broadly represents any single or multi-processor computing device or system capable of executing computer-readable instructions. Examples of computing system 100 include, without limitation, workstations, laptops, client-side terminals, servers, distributed computing systems, handheld devices, or any other computing system or device. In its most basic configuration, computing system 100 may include at least one processor 110 and a system memory 140.

Both the central processing unit (CPU) 110 and the graphics processing unit (GPU) 120 are coupled to memory 140. System memory 140 generally represents any type or form of volatile or non-volatile storage device or medium capable of storing data and/or other computer-readable instructions. Examples of system memory 140 include, without limitation, RAM, ROM, flash memory, or any other suitable memory device. In the example of FIG. 1, memory 140 is a shared memory, whereby the memory stores instructions and data for both the CPU 110 and the GPU 120. Alternatively, there may be separate memories dedicated to the CPU 110 and the GPU 120, respectively. The memory can include a frame buffer for storing pixel data drives a display screen 130.

The system 100 includes a user interface 160 that, in one implementation, includes an on-screen cursor control device. The user interface may include a keyboard, a mouse, and/or a touch screen device (a touchpad).

CPU 110 and/or GPU 120 generally represent any type or form of processing unit capable of processing data or interpreting and executing instructions. In certain embodiments, processors 110 and/or 120 may receive instructions from a software application or hardware module. These instructions may cause processors 110 and/or 120 to perform the functions of one or more of the example embodiments described and/or illustrated herein. For example, processors 110 and/or 120 may perform and/or be a means for performing, either alone or in combination with other elements, one or more of the monitoring, determining, gating, and detecting, or the like described herein. Processors 110 and/or 120 may also perform and/or be a means for performing any other steps, methods, or processes described and/or illustrated herein.

In some embodiments, the computer-readable medium containing a computer program may be loaded into computing system 100. All or a portion of the computer program stored on the computer-readable medium may then be stored in system memory 140 and/or various portions of storage devices. When executed by processors 110 and/or 120, a computer program loaded into computing system 100 may cause processor 110 and/or 120 to perform and/or be a means for performing the functions of the example embodiments described and/or illustrated herein. Additionally or alternatively, the example embodiments described and/or illustrated herein may be implemented in firmware and/or hardware.

FIG. 2A is a communication system 200A implementing a control register access bus, in accordance with one embodiment of the present disclosure. The control-register-access-bus (CRAB) provides low-cost, high-throughput, and power efficient transactional access (e.g., performing READs and WRITEs, etc.) to register based resources of the system 200A (e.g., SoC). For instance, the CRAB communication bus provides access to control registers located in core units 235 at a core level 230, CCLUSTER 220, and request ordering and coherency unit (ROC) 210 through the CRAB root-master 250 located in the ROC unit. A fairly flexible CRAB topology can be assembled from a few different components (e.g., master 250 or 255, splitter 260, slave 265, and bridge 240).

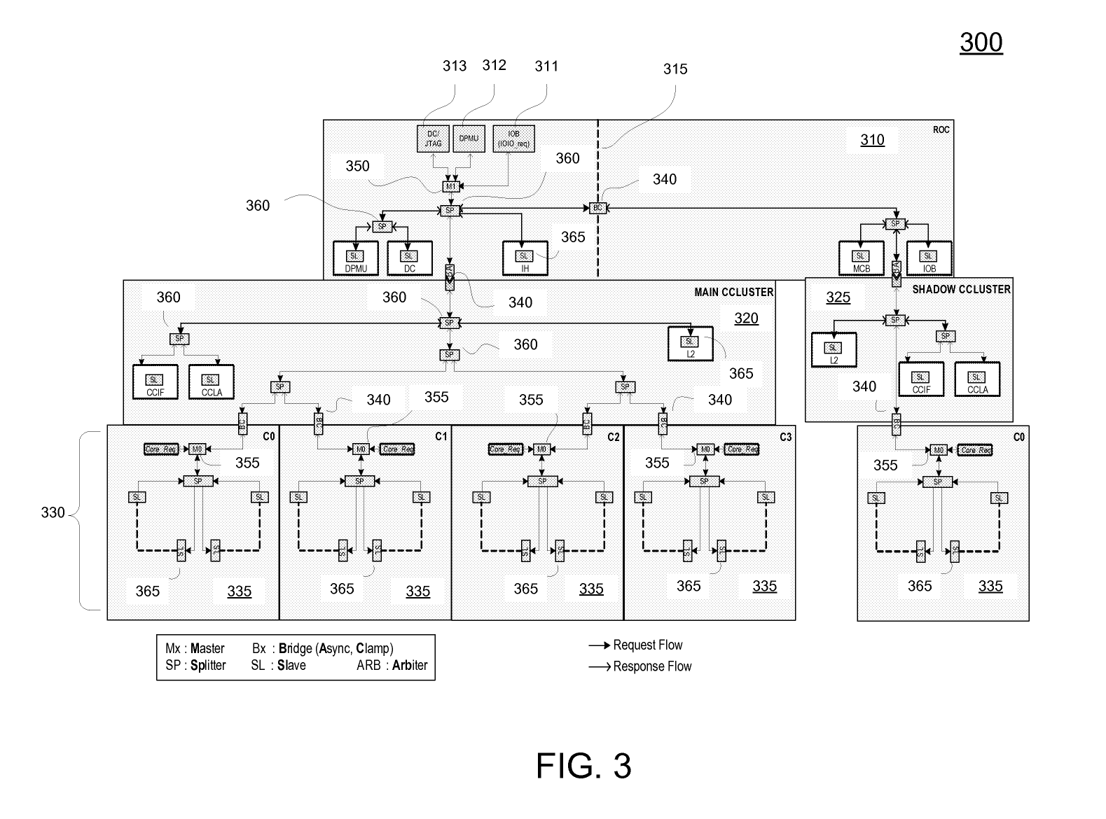

More specifically, the CRAB communication bus is configured in a hierarchical topology to provide low-cost, high-throughput, and power efficient transactional access to control registers located throughout system 200A. The top level is the ROC unit 210 and is used for scheduling transactions relating to the core registers onto the bus. A more detailed description of the ROC unit is provided in relation to FIGS. 3-6. One or more core clusters 220 (CCLUSTERs) are coupled to the ROC unit 210 through the bus. A more detailed description of CCLUSTERs is provided in relation to FIGS. 3-6. A CCLUSTER provides a gateway to one or more underlying core units 235 located at the bottom core level 230. The one or more core units 235 include one or more addressable core registers. A more detailed description of core units is provided in relation to FIGS. 3, 7, and 8A-B. The core units are coupled to the CRAB communication bus. As such, the CRAB communication bus provides access to a plurality of addressable control registers located in the ROC unit 210, the CCLUSTER 220, and the core units 230.

CRAB transactions are initiated from a root-master 250 which schedules the transactions onto the CRAB communication bus. For instance, a root-master 250 located in the ROC unit 210 is configured for handling transactions from outside sources, and for scheduling the transactions onto the CRAB communication bus. The CRAB communication bus is also configured to include multiple masters at varying levels in the bus hierarchy. For instance, core units 235 include a core-master 255 that is configured for scheduling transactions onto a local branch of the communication bus. For instance, the local branch comprises a ring bus 237 coupling slave components comprising control registers. In one embodiment, the CRAB communication bus provides relatively high-throughput, low-latency access to core control-registers (CREGs) when accessed from the same core unit through a corresponding core-master. That is, the core-master handles local requests for accessing control registers in slave components.

As shown in FIG. 2A, the CRAB communication bus includes two different kinds of busses: 1) a ring bus 237 that is used in core units 235, and a hierarchical tree structure that is used in the ROC 210 and the CCLUSTER 220. Specifically, the ring bus 237 is configured in a traditional ring structure, wherein each device is coupled to neighboring devices, and transactions travel through the ring in the same direction. Additionally, the tree structure used in FIG. 2A is built from splitter components 260 that split the CRAB communication bus into N branches. For instance, in the ROC unit, a splitter 260 splits the bus into at least two branches, wherein one branch includes slave component 265, and another branch is undefined such that block X represents a slave 265, splitter 260, or bridge 240. As shown, splitter 260 in the ROC unit also is coupled to a bridge 240 in another branch, wherein the bridge provides an interface to the CCLUSTER 220. Also, in the CCLUSTER 220, the tree structure is illustrated by another splitter 260 which splits the branch of the communication bus into one or more additional branches, wherein one branch includes a slave component 265, and another branch is left undefined, such that block X represents a slave 265, splitter 260, or bridge 240. As shown the splitter 260 in the CCLUSTER is coupled to one or more bridges 240 providing interfaces to one or more core clusters 235.

A number of CRAB slaves 265 hang off of the CRAB communication bus as destinations. There are typically a number of slaves 265 in each core unit 235 that have configuration registers that need to be accessed via the CRAB communication bus. Other slaves 265 are located at the ROC unit 210 and CCLUSTER 220. In the ring busses 237 of the core units 235, each slave acts as leaf node of a core unit as well as a repeater where it can be viewed as a part of the CRAB communication bus. In ROC 210 and the CCLUSTER 220, a slave 265 is connected to leaf nodes of a corresponding tree structure.

In addition to masters 250 and 255, slaves 265, and splitters 260, there are also bridge components 240 that sit at the boundary between the two power domains (not shown) in the ROC unit 210, and between ROC 210 and the CCLUSTERs 220, as well as between the CCLUSTERs 220 and the core units 235. A bridge 240 defines one or more nodes within one or more branches of communication through the CRAB communication bus. The bridges 240 are needed since at the different hierarchical levels, units and/or branches have different power domains that may be individually powered down. As such, a bridge 240 acts as clock/power domain crossing boundary, and is configured to provide clock/power gating support for underlying branches in the CCLUSTER 220 and the core units 235. The bridges 240 also act as filters that filter transactions based on their address so transactions are not sent to a CCLUSTER 220 or core unit 235 unless its destination slave resides there.

Each CRAB slave is assigned an identifier (UnitID), and optionally one or multiple multi-cast UnitIDs. Regular uni-cast transactions use the uni-cast UnitID. Multi-cast transactions (e.g. writing to multiple destinations in one or more core units) are performed by using a multi-cast UnitID. In that case, registers accessed using a multi-cast UnitID act as “global” registers. For instance, WRITE transactions directed to registers associated with a multi-cast UnitID will write to multiple registers in multiple core units. A READ transaction directed to multiple registers associated with a multi-cast UnitID will OR the bits together from the multiple core units, in one embodiment. As an example, this occurs when various core units will own parts of the register (e.g. one bit each), thereby enabling information (e.g. a status bit) from multiple core units to be read with a single READ transaction.

FIG. 2B is flow diagram 200B illustrating a method for implementing a communication bus, in accordance with one embodiment of the present disclosure. Although specific steps are disclosed in the flowcharts, such steps are exemplary. That is, embodiments of the present invention are well-suited to performing various other steps or variations of the steps recited in the flowchart. In one embodiment, the communication bus is implemented within the computing systems 100 and 200 of FIGS. 1 and 2.

The method includes providing a communication bus at 270 for accessing control registers. For purposes of the application, the communication bus is also referred to as the control register access bus (CRAB). In embodiments, the bus topology can be a ring (for high-throughput and low-latency), or a star (for low-latency), or a tree (for scalability and low-cost), or any combination of the aforementioned. The communication bus consists of one or more masters (which schedule packets on to bus), splitters (which split bus into two or more outgoing branches), bridges (which provide bridge for clock and/or power domain crossing), and slaves (which act as “gateway” to destination unit).

At 275, the method includes coupling one or more core units to the communication bus, wherein the core units comprise one or more addressable core registers. A core unit acts as a subsystem and includes one or more components. More particularly, slave components in a core unit include addressable registers that are accessible over the communication bus. A more detailed description of core units is provided in relation to FIGS. 3, 7, and 8A-B.

For instance, a core-master is configured in each of the core units, wherein the core-master schedules transactions onto a local branch of the communication bus that accesses slave components comprising registers. In one embodiment, components of a core unit are configured in a ring topology on a local branch of the communication bus. A core-master is the “root” of the ring bus, and is configured to schedule transactions (e.g., READs and WRITEs, etc.) onto the local ring bus in cooperation with a core scheduler. In that manner, the transactions are pipelined onto the local ring bus, which provides predictable latency through the bus because the ring topology provides for low-latency and high throughput. In another embodiment, the core unit includes multiple ring busses, and the core-master is configured to drive the multiple ring busses in order to further reduce latency.

In one embodiment, one or more destination states are associated with registers on a corresponding local ring bus of a core unit. These states are used to decouple the core scheduler of the core unit from the ring bus. As a result, the core scheduler is configured to schedule transactions based on the availability of the destination resources (e.g., registers). A destination resource is busy if its WRITE request has not been accepted by the core-CRAB-master (core-master), or its READ request has not been responded to by the core-master.

At 280, the method includes coupling one or more core clusters (CCLUSTERs) to the one or more core units through the communication bus. A CCLUSTER provides one or more gateways to and from underlying core units. In particular, a CCLUSTER includes a cluster of N core units with caches. A more detailed description of CCLUSTERs is provided in relation to FIGS. 3-6.

At 285, the method includes coupling a request ordering and coherency (ROC) unit to the one or more CCLUSTERs through the communication bus. The ROC unit includes a root-master that is used for scheduling transactions relating to the registers onto the communication bus. For instance, the root-master in the ROC unit is configured for receiving transactions from outside sources and scheduling those transactions onto the communication bus. A more detailed description of the ROC unit is provided in relation to FIGS. 3-6.

At 290, the method includes providing a plurality of addressable registers located in the various layers of the bus hierarchy. For instance, registers are located in one or more layers, including the ROC unit, the CCLUSTER, and the core units.

The communication bus includes one or more masters having access to all or a subset of the bus fabric. Control and access is dependent on the latency and throughput requirements of the relative masters. For instance, a mixed tree and ring-bus topology including the ROC unit, the CCLUSTERs, and core units is configured to provide low-cost (when considering die area, and power control) access to all the register elements of the SoC from a root-master, and low latency/high throughput within a ring bus as controlled by a core-master.

In one embodiment, the communication bus or CRAB is a locally synchronous credit based packetized bus (i.e., uses the clock of the local core unit in which the transaction is routed). A locally synchronous bus avoids asynchronous logic in a destination unit. Also, the synchronous bus allows for streaming a READ transaction to one core unit at a time, without requiring buffers in destination units. This greatly simplifies the communication bus, and provides higher throughput of a complex (i.e., high-cost in area/power) bus fabric. As such, stream READs are used for fast context-saves. This is critical for low power design and efficient power-gating.

In embodiments, the communication bus is configurable to provide power gating through branches of the communication bus. For instance, one or more of the chip partitions, as defined by the branches of the communication bus, can be power-gated, while the rest of the control register access bus can be actively used to access register resources. In particular, one or more masters can be powered off while remaining masters actively continue to provide access to remaining register resources. As an example of power gating, control is effectively provided through register control, wherein registers are programmed by a power controller (e.g., power controller 312 of FIG. 3). The register is located in the bridge itself, or on a slave component associated with or close to the bridge that is located on the power-on side. In that manner, the register is accessible when the bridge is power gated.

More specifically, a chip or SoC exhibiting low power uses many clock and power domains. In embodiments, the communication bus or CRAB uses the idea of bridges to decouple units (of different clock and/or power domains) from each other. As a result, parts of the SoC or chip can be power-gated independently. When a downstream unit is power-gated, a CRAB bridge acts as proxy for the downstream units. This makes the overall computing system more robust (i.e., less susceptible to software bugs) by “consuming” WRITEs, and responding (e.g., with a default value) to READs, both of which are targeted to a downstream unit that is power gated (e.g., OFF). Also, a bridge provides just-in-time wake window for clock-ungating downstream units. For example, if a CPU is in a clock-gated state, and a WRITE is targeted to it, an appropriate bridge provides the early-wake-indicator to clocking logic and holds the WRITE until the clock is turned on and active within the branch.

In another embodiment, to speed up initialization and/or context-restore, a multi-cast mode is used in the communication bus or CRAB, wherein the same WRITE transaction is sent to multiple clients or destination units. This can be critical in a low power design for efficient power-ungating and/or changing frequency. For example, at boot, a set of registers is written to for all the core units requiring the same data, using a multi-cast address. Similarly, multiple memory controllers have a set of registers which need to be written with same data. Simultaneous access to the memory controller registers is provided through multi-cast addressing.

The communication bus can be used to issue posted WRITEs (for higher throughput) in order to stream data to a specific unit. Also, non-posted WRITEs are used for guaranteeing ordering for a subset of registers of a core unit. Normal READs (e.g., one at a time), or stream READs (for higher throughput) are implemented through the communication bus. In one embodiment, the data (e.g., 64-bit or smaller) and address (e.g., 32-bit) are packetized into 16-bit packets and transmitted over 16-bit credit-based request bus. Also, the read response is packetized into 16-bit packets and transmitted over 16-bit credit-based bus.

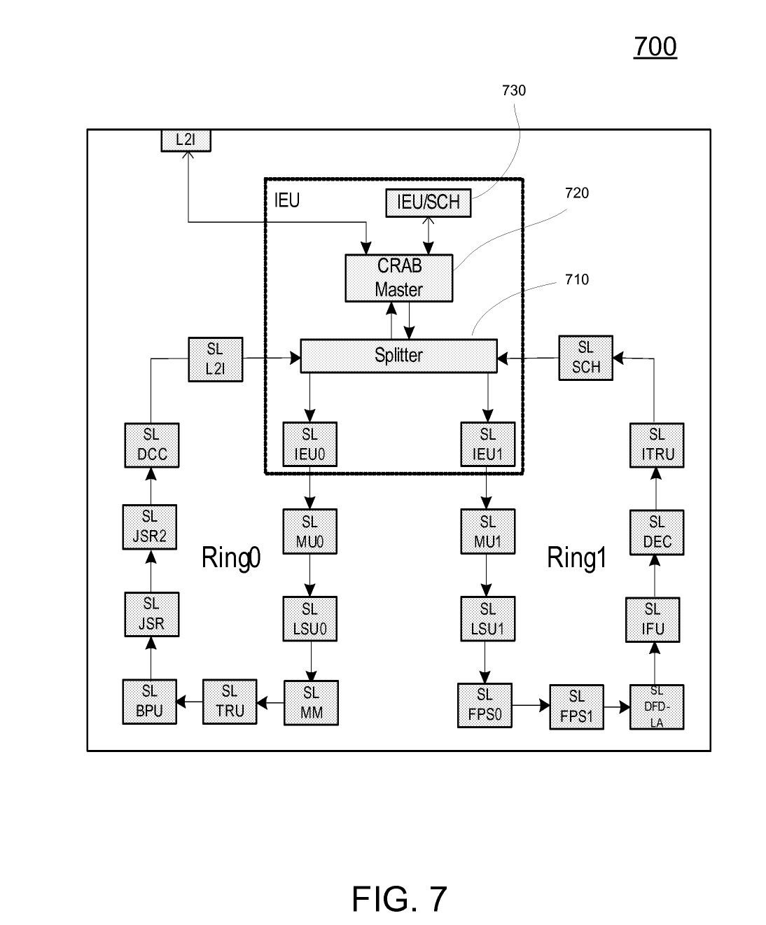

FIG. 3 is a block diagram of an exemplary system 300 implementing a control register access bus configured in a mixed tree and ring topology, in accordance with one embodiment of the present disclosure. The CRAB communication bus fabric is assembled from standard CRAB-components (e.g., master 350 and 355, slave 365, splitter 360, and bridge 340). As shown, the CRAB topology includes a ROC unit 310, a main CCLUSTER 320, and multiple core processing units C0-C3. In the core processing units C0-C3, a simplified representation is shown and illustrates two ring topologies. A more detailed illustration of the core processing unit and its local communication ring busses is provided in relation to FIG. 7.

In FIG. 3, a hierarchy is established with ROC 310, CCLUSTER 320 and shadow CCLUSTER 325, and CORE 330 levels. With this topology, the ROC root-master 350 is at the top of CRAB hierarchy, and acts as the root for controlling transactions throughout the CRAB communication bus. The root-master 350 is configured to issue requests to any of the control registers in ROC 310, CCLUSTER 320, or the core units (C0-C3) or core unit C0 in the branch controlled by the shadow CCLUSTER 325. The core-masters 355, on the other hand, can only issue requests to any of the control registers within a corresponding core processing unit.

There is a CRAB bridge 340 between each power domain that can be individually power gated. As shown in FIG. 3, there is one bridge 340 located internally within the ROC unit 310, since it consists of two domains. The bridge 340 is located on the boundary 315 as illustrated by the dashed line. The other bridges 340 are located on boundaries between ROC unit 310 and the CCLUSTER 320, and between the CCLUSTER 320 and the core units C0-C3.

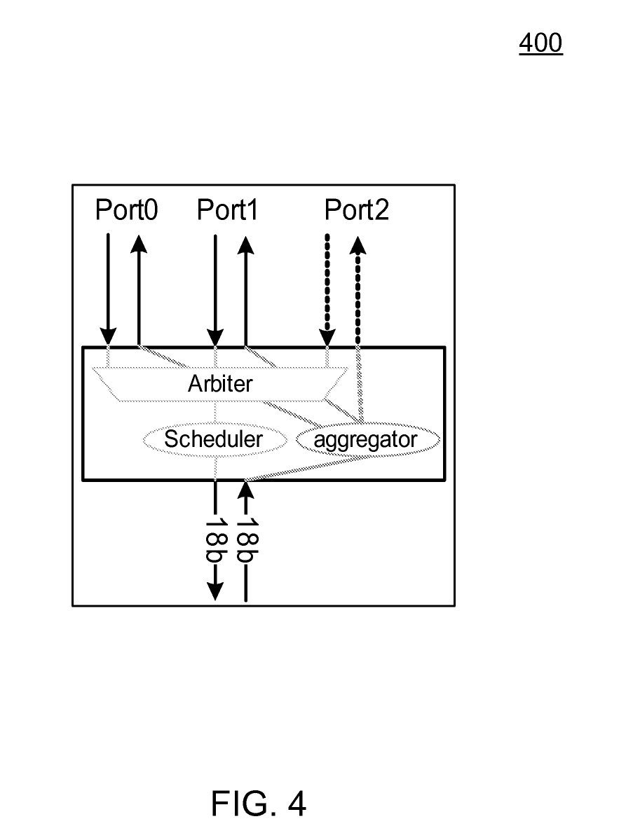

As shown in FIG. 3, the root-master 350 receives register read/write requests from sources, arbitrates them, and schedules them onto the CRAB communication bus. FIG. 4 is a block diagram of a root-master 400 configured to handle register transactions on the control register access bus, in accordance with one embodiment of the present disclosure. The CRAB root-master 350 schedules CRAB transactions based on requests and commands from three different sources: I/O bridge (IOB) 311, Debug Controller (DC) 313, or the Power Management Unit (DPMU) 312. The ROC root-master 350 will arbitrate among these three request ports. The ROC root-master 350 has room for up to 4 requests on each port, in one embodiment. The requester provides a tag with each request which is used to identify with which request a response is associated.

Requests from DC 313 will have highest priority to ensure that it never gets starved even in presence of misbehaving units, in one embodiment. If there are no pending DC requests, the master will do round-robin arbitration between IOB and DPMU. More specifically, the core processing units 335 initiate IMO traffic (e.g., using the IN/OUT uOps (micro-operations)) that arrive at the IOB unit 311. The IOB 311 will identify the traffic that has CRAB as its destination and route it to the CRAB-root, enabling all cores to access all CREGs in the system. The DC 313 has the ability to READ and WRITE to all core registers in the system 300. As such, the DC 313 has a direct connection to the root-master 350. This also enables access via JTAG (joint test action group). The DPMU 312 controls power throughout the system 300. For instance, in order to bring up the cores, as well as powering up and down individual cores and the L2 at a later moment in time, the DPMU unit 312 in ROC 310 needs to be able to access the CRAB communication bus, so it has a direct connection to root-master 350.

In one embodiment, packet delivery in the CRAB communication bus consists of 18 bits. For instance, the 18 bits include 2 control bits (e.g., a “credit” bit for flow control, and a “valid” bit) and 16 payload bits. The busses shown in the FIG. 3 actually consist of 2 busses, one in each direction.

In one embodiment, the CRAB communication bus only supports one read outstanding at any one point in time. It is unknown when a response will come back (e.g., requests sent to different slaves will not necessarily take the same time to process) and the request may not have a tag, so there is no way of matching responses with requests.

WRITEs can be posted (no ack) or non-posted (returns ack). Since there is no response that needs to be matched with a request for posted WRITEs, the CRAB communication bus supports multiple posted WRITEs outstanding simultaneously. Specifically, only one non-posted WRITE can be outstanding at any one point in time. The root-master 350 will initiate two different flavors (posted/non-posted) of writes based on the highest order address bit. The root-master 350 can only have one normal-read or non-posted write outstanding at any one point in time. Multiple posted writes or stream-reads can be outstanding simultaneously.

In ROC 310 and the CCLUSTER 320, CRAB is flow controlled, as opposed to the ring bus in the core unit 335. In this case, the root-master 350 will not send a packet downstream unless it has a credit available. Conversely, a downstream unit will not send a packet upstream unless it has a credit available. Additionally, the slaves in ROC 310 and CCLUSTER 320 also utilize a flow controlled interface. A slave 365 will return credits once it is ready to accept new packets (e.g., once it has responded to the request). If a request has a different UnitID than the slave, then the slave will return the credits immediately.

The ROC root-master 350 provides a “timeout” timer which is armed when a read or non-posted write is scheduled, in one embodiment. The timer is reset when response/ack is received. If the timer expires before the outstanding response/ack is received, then master timeouts and reports error.

In one embodiment, the CCLUSTER CRAB slave 365 has a 6 bit UnitID. The slave also decodes the AddressType bits to confirm that it the request is targeting itself, the CCLUSTER slave 365. The ROC slave 365 has a 7 bit UnitID, and also needs to decode the AddressType bits to confirm that it a request is targeting itself, in one embodiment.

The CRAB communication bus fabric is assembled from standard CRAB-components (e.g., master 350 and 355, slave 365, splitter 360, and bridge 340), so the CRAB topology is flexible. The number of CRAB slaves 365 depends on the physical placements of control registers within each core processing unit (C0-C3) so some core units may end up having multiple slaves 365.

The normal CRAB slave 365 comes with an auto-generated register file. Some units require special functionality, e.g. backdoors for the registers. This can be achieved by using a slave with external registers. For this CRAB component, the register file will not be auto-generated but need to be manually instantiated and hooked up to the control signals that are provided by the external slave.

The splitter 360 of FIG. 3 is used to split the CRAB communication bus into two (or more) branches. For instance, a 1-to-2 splitter is shown in FIG. 3, but 1-to-3 and 1-to-4 splitters also are supported. If needed, 1-to-N splitters can be built by cascading these splitters.

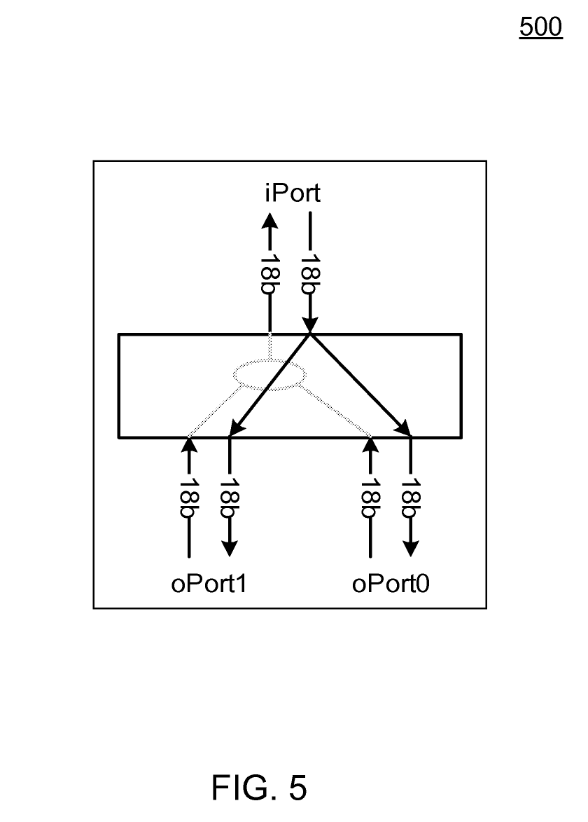

FIG. 5 is a block diagram of an exemplary splitter 500 used for distributing register transactions to multiple destinations, in accordance with one embodiment of the present disclosure. In one embodiment, splitter 500 does not have an internal FIFO, and hence the credits tracked by the upstream unit are associated with the FIFOs in the receiving units downstream of the splitter. An incoming packet to the splitter 500 will be broadcast down all its legs. The splitter 500 will keep track of credits returned from each of its legs and only return a credit upstream once all of its legs have returned a credit.

In one embodiment, there will be a counter per leg. Each time a credit is returned from downstream, the corresponding counter is increased. Once all counters are non-zero, a credit can be returned upstream and all counters can be decreased by one. Responses from the legs are all ORed together. This is acceptable, since there are only one READ or non-posted WRITE outstanding at any one point in time, so responses will not arrive at multiple legs at the same time.

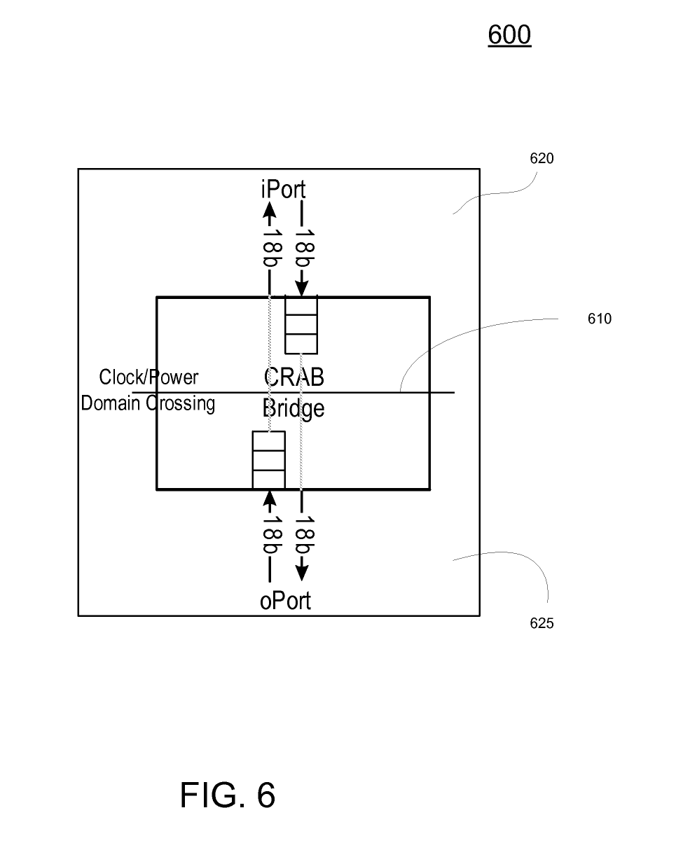

FIG. 6 is a block diagram of an exemplary bridge 600 defining a branch node, wherein a bridge provides clock and/or power gating for underlying branches, in accordance with one embodiment of the present disclosure. The bridge 600 is used at clock and/or power-domain boundaries, and provides flow control for both upstream (for requests) and downstream (for responses).

The bridge 600 has two main purposes, both of which are needed for correct functionality. First, the bridge 600 filters requests based on addresses. Only requests targeting the unit below the bridge should pass through the bridge (e.g., a bridge between the CCLUSTER and core processing unit C0 should only let through requests for core C0). This is required since the slaves in the core do not consider the CoreID but only the UnitID of the address. Second, the bridge 600 ensures that the CRAB communication bus works correctly in presence of requests that target clock and/or power gated units. That is, bridge 600 is configured to connect to the power management units in the CCLUSTERs and to the DPMU in the ROC unit to enable this functionality.

As shown in FIG. 6, bridge 600 is located on the boundary 610 between two domains. The bridge 600 has two halves, bridge-upstream 620, and bridge-downstream 625, which are instantiated in upstream and downstream clock/power domains, respectively. There are two different type of bridges based on the interface between two halves of the bridge.

In one embodiment, bridge 600 uses an asynchronous interface between the two halves. It is used for an asynchronous clock (power-domain) crossing boundary. In one embodiment, this will be used for the crossing between ROC and the CCLUSTERs. Thus, the address filtering behavior for this bridge should filter based on CCLUSTERID.

Also, in bridge 600, the two halves 620 and 625 interface without any logic in the middle. However, the signals from one half to the other can be clamped (e.g., for power-gating). As such, bridge 600 is used for power-domain crossing interfaces. In another embodiment, bridge 600 is used for the crossing between the two domains in ROC itself, as well as between the CCLUSTER and the core processing units. More specifically, a bridge 600 located internally within a ROC unit does not perform any address filtering. A bridge 600 that interfaces between the CCLUSTER and the core processing units performs address filtering based on CoreID.

In one embodiment, bridge 600 is used to perform clock gating. As such, bridge 600 keeps track of any outstanding requests for which it has not yet received a response. This indicates when clock gating of the domain below is not permitted. Also, in another embodiment, bridge 600 is configured to hold on to requests that arrive when the domain below is clock gated. As such, the bridge 600 is configured to request that the clock is un-gated, and then forwards the request after the clock is un-gated.

In one embodiment, bridge 600 is used to perform power gating. Bridge 600 is configured to keep track of any outstanding requests for which it has not yet received a response. This indicates when clock gating of the domain below is not permitted for purposes of power control and power gating. This exhibits similar functionality as for clock gating.

Also, bridge 600 is configured to be told to “nack” (negative acknowledgment) requests instead of forwarding them. The bridge 600 is configurable to pick an appropriate boundary (typically the boundary between two CRAB transactions) for when this is legal before starting to nack requests. Once the bridge 600 has acknowledged that it is nacking requests and have no outstanding requests, then the domain below can be power gated.

FIG. 7 is a diagram illustrating a topology for a local ring bus (ring-0 and ring-1) for a core unit 700 located on a control register access bus, in accordance with one embodiment of the present disclosure. In particular, core processing unit 700 includes a local communication bus, including two rings: ring-0 and a ring-1 that are accessible through splitter 710. The local bus is coupled to and considered part of the CRAB communication bus.

In one embodiment, the width of the ring-busses shown is 18 bits (1 “idle” bit for clock gating, 1 “valid” bit, and 16 bits for payload). All register read/write requests go to both rings through splitter 720. In one embodiment, both ring-0 and ring-1 have the same latency.

Core processing unit 700 includes one or more slave components, wherein the slave includes one or more control registers, and each slave provides a transaction interface to corresponding registers contained within. The core processing unit is coupled to the communication bus. That is, core processing units containing control-registers that need to be accessed via the CRAB communication bus each instantiate a CRAB-slave which acts as ring-repeater and also provides register read/write interface to the unit. For instance, ring-0 includes multiple slave components (e.g., SL-IEU0, SL-MU0, SL-LSU0, SL-MM, SL-TRU, SL-BPU, SL-JSR, SL-JSR2, SL-DCC, and SL-L2I). Ring-1 also includes multiple slave components (e.g., SL-IEU1, SL-MU1, SL-LSU1, SL-FPS0, SL-FPS1, SL-DFD-LA, SL-IFU, SL-DEC, SL-IRU, and SL-SCH). Each slave is assigned one or more identifiers (UnitIDs) to address it. The address/control phase of the protocol provides the UnitID for a transaction, which the CRAB-slave decodes to identify if the transaction targets this particular unit (or multiple units in case of multi-cast write request).

As shown in FIG. 7, the core unit 700 contains one core-master 720 that can schedule transactions onto the two ring busses (ring-0 and ring-1). These transactions are incoming transactions from an overlying CCLUSTER through port L2I, that are basically just repeated by the core-master 720. Also, these transactions can originate from the core-master 720 itself as a result from specific uOps executed by the core unit 700 through the scheduler (IEU/SCH 730).

The core-master 720 arbitrates with fixed priority, in one embodiment. The core-master 720 is configured with two request ports. One port is for local messaging, and another port is for incoming (remote) requests initiated from the ROC root-master (e.g., 350 of FIG. 3). By default, the ROC incoming port has higher fixed priority over core requests so that if the DC sends a request to the ROC master, then it is guaranteed to make it to its destination

The IEU/SCH 730 interfaces with the local core-master 720. In one embodiment, READ and WRITE transactions are pipelined onto the ring busses (ring-0 and ring-1). As such, READ and WRITE requests on the ring bus are pipelined so multiple requests can be outstanding at any one point in time.

In particular, the scheduler (SCH) in IEU/SCH 730 maintains 6 bits, one per IEU dest-N control register. The number 6 is provided as an illustration of six control registers. A bit is set when a uOp (e.g., creg2ieu.destN or gpr2creg) is issued from the SCH, indicating that the corresponding dest-N resource is busy (e.g., in process of being written or used for serialization). As such, SCH guarantees that there is never more than six outstanding ring-bus register read/write requests. When the core-master 720 receives the completion (from the ring-bus) of a READ or a WRITE transaction, it signals (as soon as possible) early completion to SCH along with the TAG of that request. After receiving the read data from ring-bus, the core-master 720 returns read data to IEU along with the TAG of that request.

The core register uOps are associated with 3-bit dest-N identifier (also referred to as dest-N TAG in this application). They are issued to IEU along with TAG. IEU transfers control-register read/write requests (along with TAG) to a core-master 720. The core-master 720 signals the early completion of a control register read/write to SCH in IEU/SCH 730 along with the TAG. Upon receiving completion signal, SCH marks the corresponding dest-N as free.

In summary, SCH in IEU/SCH 730 can schedule core register uOps (e.g., creg2ieu or gpr2creg) if a corresponding dest-N, to which the uOp is targeted, is NOT busy. That is, a core register uOp does not tell the core-master to initiate a transaction until the uOp actually completes. Hence, the core-master 720 does not need the ability to cancel a request. SCH is expected never to allow more than 6 outstanding core register uOps, since the CRAB ring topology in a core processing unit cannot handle higher throughput given the number of packets in a transaction and the ring latency, in one embodiment.

The integer execution unit (IEU) unit in IEU/SCH 730 sends to the core-master 720 64 bit or 32 bit register READ/WRITE requests along with a 3-bit TAG, which needs to be returned with the completion of that request. The core-master 720 needs to be able to buffer six IEU requests, in one implementation.

In one embodiment, IEU in IEU/SCH 730 interfaces with the core-master 720 and transfers register read/write uOps to the core-master 720 in a controlled manner. That is, the IEU is configured to track availability of the one or more control registers in the core processing unit, and to interface with the core-master for scheduling those transactions onto the local bus based on the availability. The core-master 720 will not be instructed to initiate a transaction until the uOp is completed, so the core-master 720 does not need the ability to cancel transactions. It also allows control-register WRITEs and READs to be issued without explicitly pre-serializing against older potentially eventing and replaying bundles. The assumption here is that the additional cycles of latency is not significant when compared with the benefit of removing the pre-serialization behavior

Core-master 720 is configured to send signals to the IEU in IEU/SCH 730 to indicate the completion of a register read on the ring-bus. In one implementation, the completions are in-order. Also, the core-master 720 does send a TAG (identifier) of the dest-N, to which a READ completion is targeted.

As an illustration, the IEU in IEU/SCH 730 has six 64-bit control data registers. Each control register read specifies a data register where the result data will be written. These control register data registers are single-copy state (not shadowed), in one embodiment. In another, the control registers are shadowed.

The core-master 720 schedules packets on to the ring busses based on the core ring-bus pipeline. Also, the core-master 720 will be receiving requests back on the upstream side (e.g., through the ring-bus) in order to generate error-responses for invalid READ UnitIDs, and write-acks for WRITEs.

For incoming requests initiated by the ROC root-master, the core-master 720 interfaces with the bridge at the boundary between the CCLUSTER and the core processing unit 700. The core-master 720 provides credit based flow control to the bridge. The core-master gives higher priority to incoming requests. Note that the core-master 720 arbitrates between local requests and incoming requests at transaction granularity. In general, packets from two different (e.g., READ or WRITE) transactions are not interleaved, with the exception of a so called “paired READ” requests. Additionally the core-master 720 schedules incoming read-requests from the root-master only if it has enough credits to be able to send read response back to the bridge.

In one embodiment, transactions are sent on both ring busses through splitter 710, even though for the cases of non-multi-cast reads/writes, only one of the rings needs the transaction. Also note that the results of both rings are ORed together. When a READ transaction is issued, the core-master 720 will send “empty” packets on the data phases. In another embodiment, transactions are sent on the appropriate bus through addressing.

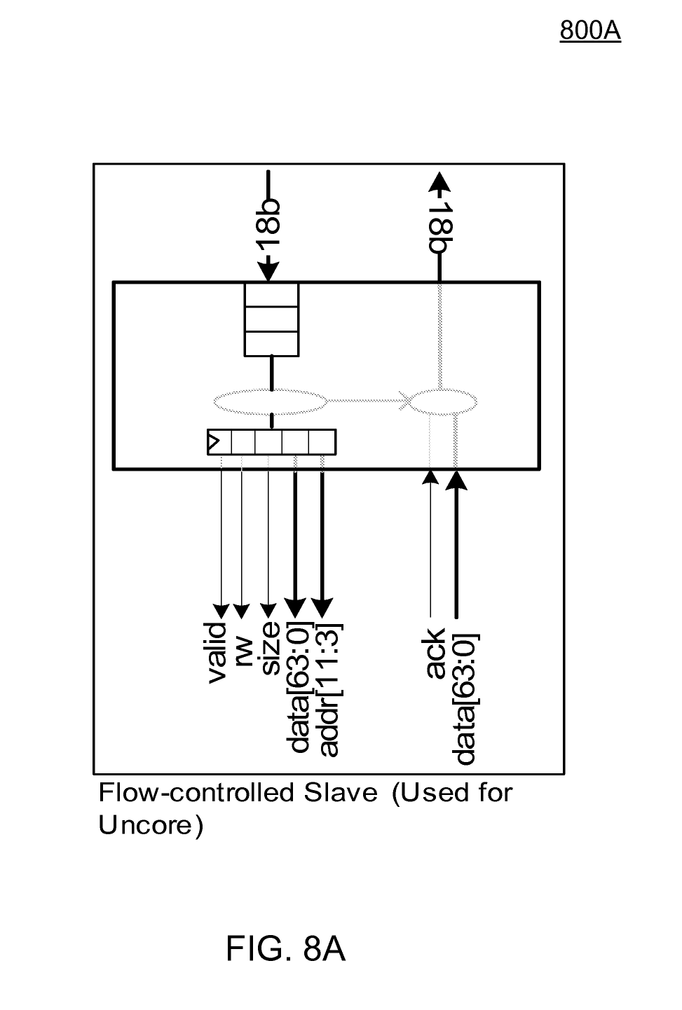

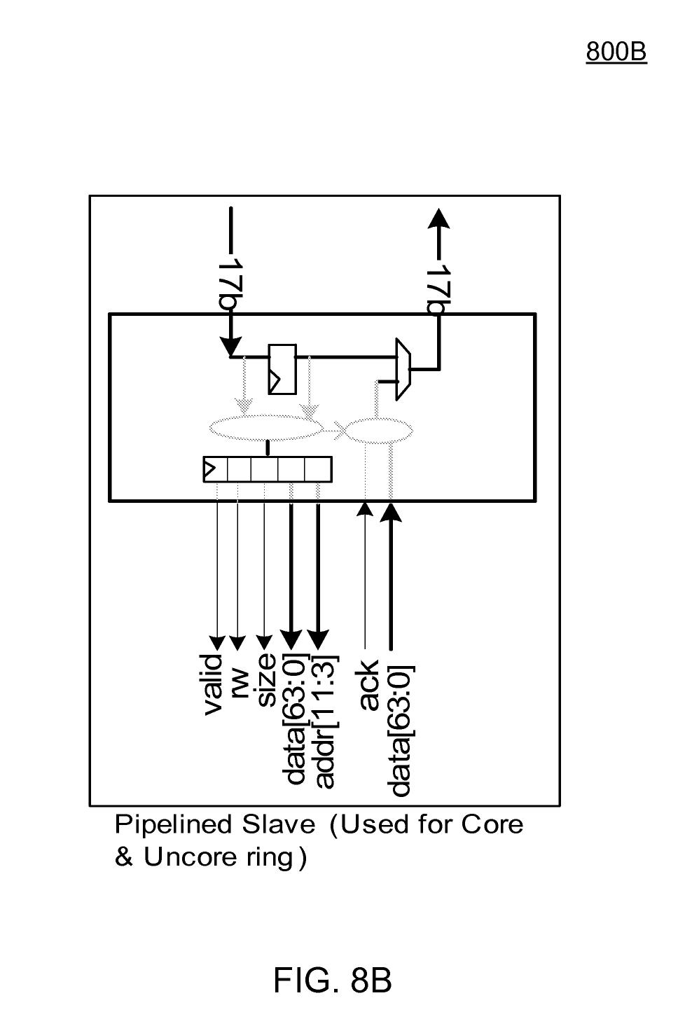

A CRAB slave component is instantiated in every unit which incorporates control registers. For instance, FIG. 8A is a diagram illustrating a flow-controlled slave component 800A that is used for uncore units (units outside of cores) accessible through a control register access, in accordance with one embodiment of the present disclosure. Also, FIG. 8B is a diagram illustrating a pipelined slave component 800B accessible through a control register access bus that is used for ring topologies in the core and uncore units, in accordance with one embodiment of the present disclosure. For illustration, in a core processing unit, the ring bus may include multiple slave components (e.g., SL-IEU0, etc. as shown in FIG. 7 of ring-0). A slave component receives packets and “parallelizes” them into register READ/WRITE requests when the request is targeted to its associated unit. The slave component presents the valid register READ/WRITE request to the associated unit.

In particular, a slave component is instantiated with one or more UnitID(s), which is (are) used to decode whether a request is targeted to its associated unit. For illustration, the UnitID for core slaves consists of 5 bits. In that case, there can be up to 32 slaves in the core.

In one embodiment, the CRAB slave component used in the core processing unit 800B is designed to be used with a ring bus topology. That is, the slave component does no flow control, and pipelines the request to the next slave. For instance, the slave component acts as a ring-repeater.

For illustration, when considering control register access requirements, the core processing unit is configured to provide two 16-bit wide control register ring busses as shown in FIG. 7. Each ring is configured with one more slave components or units. In one implementation, the rings are configured to have the same fixed latency (e.g., approximately 30 core clocks with 8 slave components). Also, the core-master 720 allows access from the IEU0 data path, and also from incoming transactions from the root-master in the ROC unit through CCLUSTER via L2I. In addition, core CRAB topology is run at full core frequency. Also, support for global (multi-cast) writes (a single control register ring write can update copies of the same logical state in multiple units), and multi-cast reads.

The following control register uOps are defined which are related to the control register ring bus. The uOp “gpr2creg.destN{.32/.64}” writes a control register with address and data specified in integer registers. This uOp has no integer register destination. The .32 version writes 0's in the upper 32 bits of the control register (if implemented). The uOp “creg2ieu.destN{.32/.64}” reads a control register and writes the data to one of the internal destN registers in the IEU. This uOp has no integer register destination. The .32 version writes 0's into the target destN register. The uOp “ieucr2gpr.destN” reads the specified destN state and writes 64 bits to an integer register destination. The uOp “gpr2ieucr.destN” writes 64 bits to the specified destN state with an integer register source. This uOp is used for save/restore.

In one embodiment, the uOps described above will stall at the scheduler if there is an older gpr2creg or creg2ieu uOp specifying the same destN which hasn't completed, exited the control register ring bus, and written a value to destN (if applicable). Also, the gpr2creg and creg2ieu uOps do not start an access on the control register ring bus until their bundle completes. This removes the need for pre-serializing these accesses against prior events.

For an illustration of the core-master 720 scheduling transaction onto the ring busses (ring-0 and ring-1), the IEU in the IEU/SCH 710 will implement six destN 64-bit “registers” (dest0-dest5). This allows the control register bus to be fully utilized when doing 32-bit control register reads or writes.

The CRAB protocol consists of READ and WRITE transactions each having a 32 bit flavor and a 64 bit flavor. Outside of the cores, the WRITE transactions can be posted (ack is returned even before the WRITE has taken effect) or non-posted (ack will not be returned until the WRITE has reached the final destination), while the WRITES in the core processing units are always non-posted.

CRAB transactions are initiated from the CRAB masters (e.g., root-master and core-master) in the system. There is one core-master in each core processing unit, and additionally a root-master in the ROC unit. The core-master initiates CRAB transactions as a result of specific uOps being executed in that core. It also passes on transactions received from the root-master in ROC via a tree of splitters and bridges. The root-master initiates transactions as a result of traffic from the three sources, previously described: IOB (IMO traffic), DC and DPMU that all connect to the CRAB root.

The above mentioned CRAB transactions consist of one or more packets. A CRAB packet is 16 bits payload+2 bit sideband signals. The first packet identifies the type of the CRAB transaction. This first CRAB packet also contains a CRAB UnitID which is used to route the packets to the right destinations. The subsequent packets contain additional addressing information and data. For instance, a destination slave/unit can be uniquely identified using a hierarchy of identifiers, which includes identifiers for various levels, such as, CCLUSTER-ID, Core-ID, and Unit-ID (referring to a slave or unit). The terms “unit” and “slave” may be used interchangeably in this application. A unit may have multiple slaves. In this case, these slaves have different UnitIDs.

In general, the UnitID is unique within the same hierarchy level but not system wide unique. That is, two different units (slaves) within the same core would have different UnitIDs but the same UnitIDs would be present in multiple cores. In order to support multi-cast within a core (or CCLUSTER or ROC), a unit can be assigned one or more multi-cast UnitIDs in addition to its regular UnitID.

The CCLUSTER-ID and Core-ID are used to route the transaction to the correct CCLUSTER/Core, but are then ignored by the slaves themselves. That is, within a core processing unit there is no notion of CoreID, and it is assumed that any transaction that arrives at the core is targeting slaves in that core. If the transaction originates from components in the core processing unit, the local core-master routes the transaction on the local bus without going through the root-master. In the case where the transaction originates from the root-master in ROC, the bridge components are responsible for filtering request so that they are only routed to their destination CCLUSTER and core processing unit.

In one implementation, the CRAB addressing scheme allocates 9 address bits (512 registers) for each CRAB slave in ROC and CCLUSTER while it is limited to 7 bits (128 registers) per slave for slaves in the core processing unit, as will be further described. The reason that the core slave space is restricted to 7 bits is that Core registers can be accessed via special uOps and they only have 12 bits available for addressing 5 of these bits are used to identify the slave so 7 are left.

The 32 bit address is interpreted differently depending on if the address targets a slave in ROC, CCLUSTER or Core. Bits 26:25 identifies if it is a ROC, CCLUSTER or Core slave. Table 1 describes the address type encoding (how to interpret bits 26:25).

TABLE 1

| Bits 26:25 | Hierarchy level |
|---|---|
| 00 | Core |
| 01 | CCLUSTER |
| 10 | ROC |
| 11 | Reserved |

Tables 2, 3, and 4 describe how to interpret the full address depending on what type of unit the AddressType indicates.

TABLE 2

| | 26:25 | 24:21 | 20:16 | 15:11 | 10:4 | 3:0 |
|---|---|---|---|---|---|---|
| 31:27 | (2 bit) | (4 bit) | (5 bit) | (5 bit) | (7 bit) | (4 bit) |
| TransType | AddressType | CCLUSTERID | CoreID | CoreUnitID | RegNo | 0000 |

TABLE 3

| | 26:25 | 24:21 | | 16:12 | 11:3 | 2:0 |
|---|---|---|---|---|---|---|
| 31:27 | (2 bit) | (4 bit) | 20:17 | (5 bit) | (9 bit) | (3 bit) |
| TransType | AddressType | CCLUSTERID | Rsrvd | CCLUSTERUnitID | RegNo | 000 |

TABLE 4

| 31:27 | 26:25 (2 bit) | 24:17 | 16:12 (5 bit) | 11:3 (9 bit) | 2:0 (3 bit) |
|---|---|---|---|---|---|
| TransType | AddressType | Rsrvd | ROCUnitID | RegNo | 000 |

The CRAB communication bus supports reads and posted/non-posted write transactions as previously described. Each transaction is made from one or more packets.

Table 5 summarizes the various types of CRAB transactions that can be sent to the ROC CRAB master. A transaction is either a read or a write, its size is 32 or 64 bit and writes can be posted or non-posted. All in all, this adds up to 6 different types of transactions.

TABLE 5

| Direction | Size | Posted/Non-posted |
|---|---|---|
| Read | 32 bit | N/A |
| | 64 bit | N/A |
| Write | 32 bit | Posted |
| | | Non-posted |
| | 64 bit | Posted |
| | | Non-posted |

The agents that initiate these transactions explicitly tell (via dedicated side-band signals) the root-master if it is a READ or a WRITE and if the size is 32 bit or 64 bit. The information about if a WRITE is posted or non-posted is encoded in the address (by bit 31). The reason for this asymmetry is that the agents that issue transactions (IOB, DPMU and DC) has explicit information about read/write and 32b/64b while they know nothing about posted versus non-posted. The concept of posted WRITES only applies to the ROC root-master, and is used to determine when an “acknowledgment” is needed for a WRITE. All WRITEs initiated from the core-master are non-posted.

READ transactions have multi-cast versions where data from multiple registers in one core/CCLUSTER/ROC are ORed together, in one embodiment. This is orthogonal to the type of write and is indicated by targeting a multi-cast UnitID. In addition, WRITE transactions have multi-cast versions which write to multiple registers in one core/CCLUSTER/ROC topology. This is orthogonal to the type of WRITE and is indicated by targeting a multi-cast UnitID.

In one implementation, WRITE transactions do not have a byte mask so a WRITE will update all bytes covered by the size of the WRITE. For instance, the DNI uOps IN and OUT do not have byte masks but they only have two legal values and are used to distinguish between 32 bit and 64 bit transactions.

The CRAB “fabric” is largely a transport mechanism to transport CRAB packets. CRAB flow control is flow-control of packets and not transactions. For example, if a CRAB component has a response pending and has fewer credits than response data packets, then data packets are allowed to be separated in time. In general, the master (e.g., core-master and root-master) is the only agent which needs to schedule/accumulate request/response transactions while the other components only need to deal with individual packets. The exception to this is that bridges need to keep track of transactions, if they have sent a transaction that will generate a response, and the response has not yet arrived. Tracking is for clock and power gating purposes.

In one implementation, each unit that send request packets downstream starts out with a number of credits equaling the FIFO size of the unit below it. Conversely, each unit that send response packets upstream starts out with a number of credits equaling the FIFO size of the unit above it. By tracking credits, packets can be scheduled onto the bus without conflict or loss. If there is a splitter downstream, then the number of credits of the upstream unit equals the number of entries in the smallest FIFO of the downstream units. In practice the FIFOs will typically have the same size, which defaults to being sized to hold 4 transactions (not packets).

For purposes of credit tracking, the CRAB bus outside of the core processing unit consists of 16 payload bits and 2 side-band bits: 1 valid bit; and 1 credit bit (traveling in the opposite direction). The upstream unit (e.g. the master) will send a packet (valid will be asserted and the payload bits will have valid data) and decrease its credit count. A number of cycles later (depending on distance and how long it takes to process the transaction) the downstream unit will assert the credit bit and the upstream unit can increase its credit count. The bus is clocked at ROC frequency in ROC and core frequency in the CCLUSTERs.

CRAB packets are of the same size, 16-bit payload. In addition there are sideband bits used for flow-control and clock gating. The transactions described in the previous section consist of Command/Address (CA) packets and Data (D) packets. For instance, CRAB transactions begin with two CA packets CA0 and CA1 (each being 16 bits). They are formed as shown in Table 6.

TABLE 6

| Command Bits | Name | Description |
|---|---|---|
| CA0 [11:0] | CrabUnit | CRAB Unit ID. |
| | ID | |
| CA0 [15:12] | CmdType | See Table 7. |
| CA1 [8:0] | AddrOffset | RegNo within a unit. |
| CA1[15:9] | Rsvd2 | Core CRAB Master uses Rsvd2[2:0] as |
| | | TAG.. |

The encoding for the 4 bit command is shown in Table 7. The CRAB master selects the appropriate command based on the sideband signals that indicates if the transaction should be a read/write, 32b/64b, and based on the most significant address bits indicating if a write should be posted or non-posted.

TABLE 7

| Encoding | Description |
|---|---|
| 0000 | 64 b posted write |
| 0001 | 32 b posted write |
| 0010 | 64 b read |
| 0011 | 32 b read |
| 0100 | Reserved |
| 0101 | Reserved |
| 0110 | Reserved |
| 0111 | Reserved |
| 1000 | 64 b non-posted write |
| 1001 | 32 b non-posted write |
| 1010 | Reserved |
| 1011 | Reserved |
| 1100 | Reserved |
| 1101 | Reserved |
| 1110 | Reserved |
| 1111 | Reserved |

Depending on the type of transaction, the CA packets will be followed by up to four data packets (D0-D3). A READ transaction does not have any data packets (from the master) but will result in a slave sending out READ response packets. WRITE transactions have 2 or 4 data packets depending on if it is a 32 bit or 64 bit WRITE. Table 8 lists number and order of packets in each of the transactions.

TABLE 8

| | Packet0 | Packet1 | Packet2 | Packet3 | Packet4 | Packet5 |
|---|---|---|---|---|---|---|
| Write Req | CA0 | CA1 | D0 | D1 | D2 | D3 |
| (64 b) | | | (15:0) | (31:16) | (47:32) | (63:48) |
| Write Req | CA0 | CA1 | D0 | D1 | | |
| (32 b) | | | (15:0) | (31:16) | | |
| Read Req | CA0 | CA1 | | | | |
| (32/64 b) | | | | | | |
| Read Resp | D0 | D1 | D2 | D3 | | |
| (64 b) | (15:0) | (31:16) | (47:32) | (63:48) | | |
| Read Resp | D0 | D1 | | | | |
| (32 b) | (15:0) | (31:16) | | | | |
| Empty | All | | | | | |
| | zeros | | | | | |

The architecture for the core processing unit includes a ring-bus topology, as previously described. Packets can be fully pipelined on these ring busses or can have any number of cycles between them. Packets always flow in-order from the source to a destination, in one embodiment. In general, packets from two different transactions cannot be interleaved with the exception of paired READ transactions.

For illustration, the bus is clocked at core clock frequency and consists of 16 bits of payload+2 sideband bits. The sideband bits include a valid bit to indicate that a valid packet is being sent this cycle, and an idle bit that can be used for clock gating.

In the core ring there is no flow control. The ring bus is pipelined. In each cycle, a packet will advance to the next slave. Since there is no flow control on the ring bus itself, the core-master will not send a packet onto the bus unless it has space to handle the response. This is performed through credit tracking previously described.

In particular, the idle bit will be used to clock gate the CRAB slave. The core-master is responsible for de-asserting it one cycle before the core-master sends a transaction on the bus. The core-master then needs to keep the bit de-asserted until the end of the transaction, even if some of the packets from the core-master are empty (e.g., for READ transactions where the core-master sends two command/address packets, and a slave component is expected to send the data packets after two empty cycles). The core-master must hold the idle-signal de-asserted from one cycle before the first command/address packet, throughout the empty cycles as well as the cycles when the slave is expected to provide data. The idle signal will be flopped by the slave components as any other signals on the bus. The idle-signal can be disabled with a configuration bit and will also be connected to the debug bus to reduce risk and enable debug.

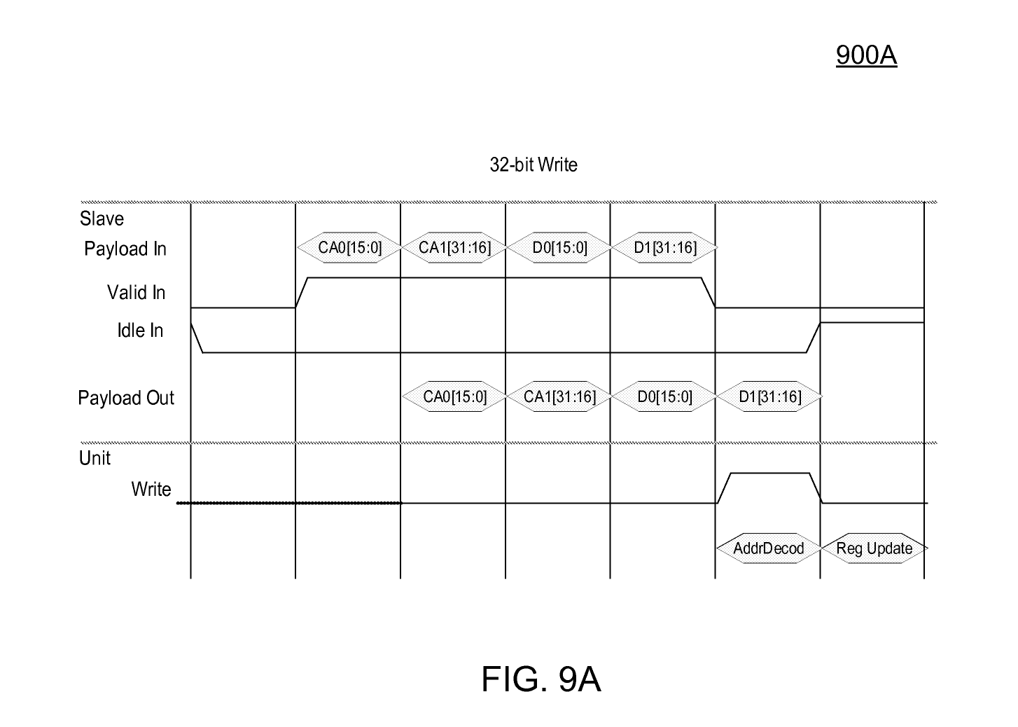

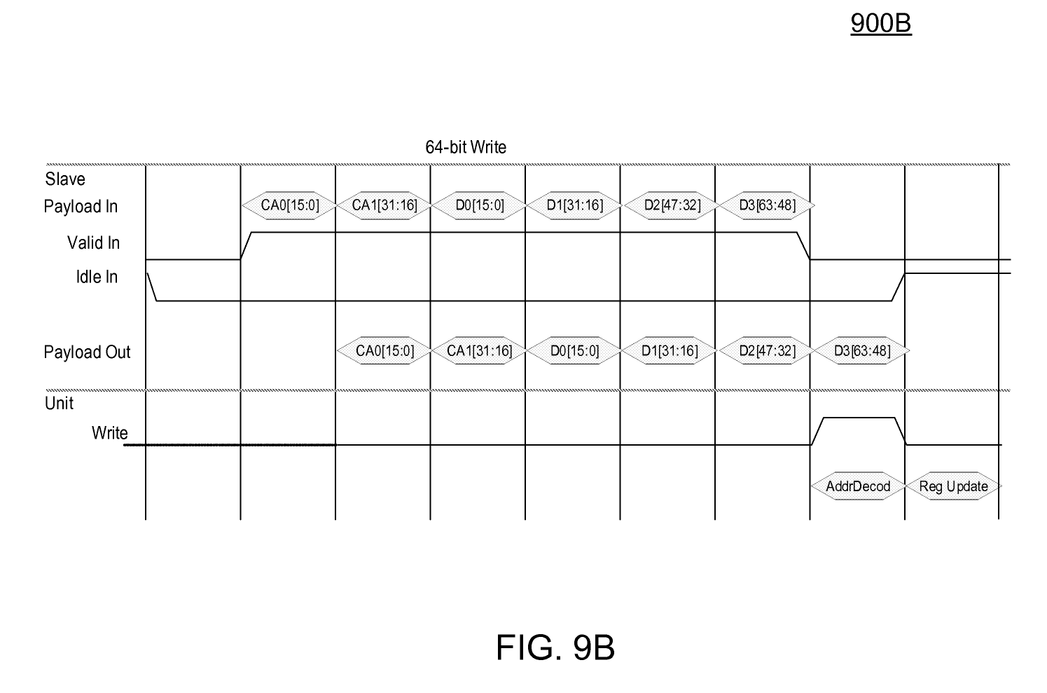

FIGS. 9-11 describe the timing of the CRAB protocol on the ring bus. It includes handling of WRITE, READ, paired READ, and WRITE after READ transactions.

FIG. 9A is an illustration of a 32-bit WRITE pipeline, in accordance with one embodiment of the present disclosure. For instance, FIG. 9A shows the packets of a 32 bit WRITE transaction. The transaction includes two Command/Address (CA) packets followed by two data packets. The CRAB slave component relays the packets on its output the cycle after it receives it.

FIG. 9A only shows the valid and idle signals on the input. They output signals are omitted but will trail the inputs by one cycle just like the payload. Note that the idle signal is not the inverse of the valid signal since one cycle is needed to ungate the clock in order to handle the first packet in time.

FIG. 9B is an illustration of a 64-bit WRITE pipeline, in accordance with one embodiment of the present disclosure. As shown in FIG. 9B, the 64 bit WRITE is similar to the 32 bit WRITE with the exception that there are four data packets instead of two.

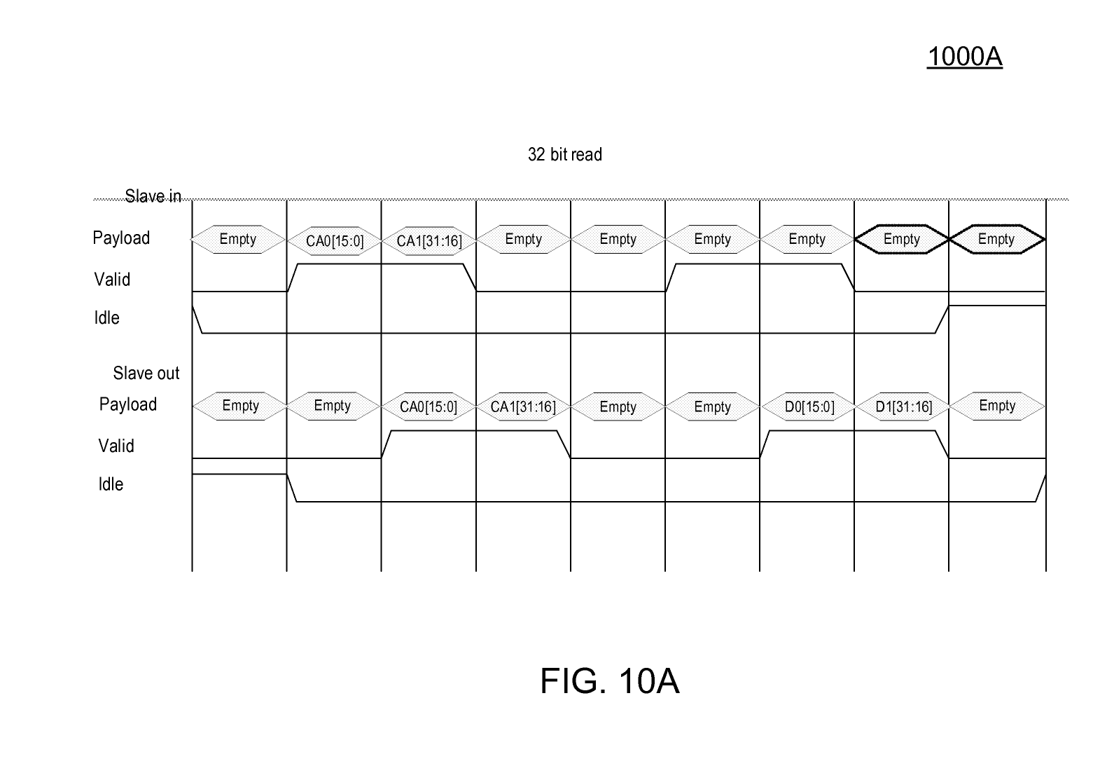

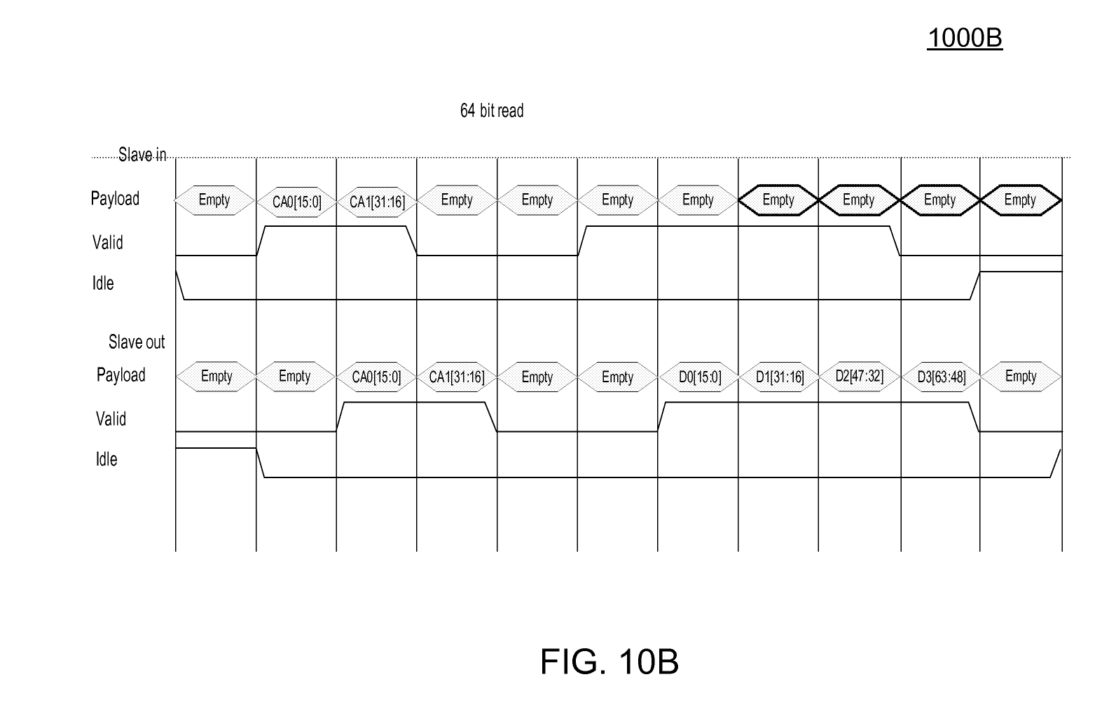

FIG. 10A is an illustration of a 32-bit READ pipeline, in accordance with one embodiment of the present disclosure. FIG. 10A shows the timing of a 32 bit READ. The master (e.g., core-master and/or root-master) sends two Command/Address (CA) packets and then sends empty packets (all zero). The straightforward implementation would then be that the slave outputs the two data (D) packets in the two cycles following the CA packets, but in order to meet timing, two empty cycles are inserted between the CA packets and the D packets.

In FIG. 10A, the master drives the valid signal for the two CA packets and for the two empty packets that correspond to where the slave will output D packets. Slaves not involved in the transaction will relay this valid signal, and the slave that matches the address will output the D packets. The idle signal is de-asserted throughout the transaction, including a cycle before and after as well as during the two empty cycles that do not contain valid packets.

FIG. 10B is an illustration of a 64-bit READ pipeline, in accordance with one embodiment of the present disclosure. FIG. 10B shows the timing of a 64 bit READ. It is similar to the 32 bit READ, but there are four D packets instead of two. As described above, two empty cycles are inserted between the CA and D packets for READ transactions in order to facilitate timing for the slaves. As a result, the ring bus may be occupied for six cycles for a 32 bit READ, although only four packets are required, and eight cycles for six packets for 64 bit READs.

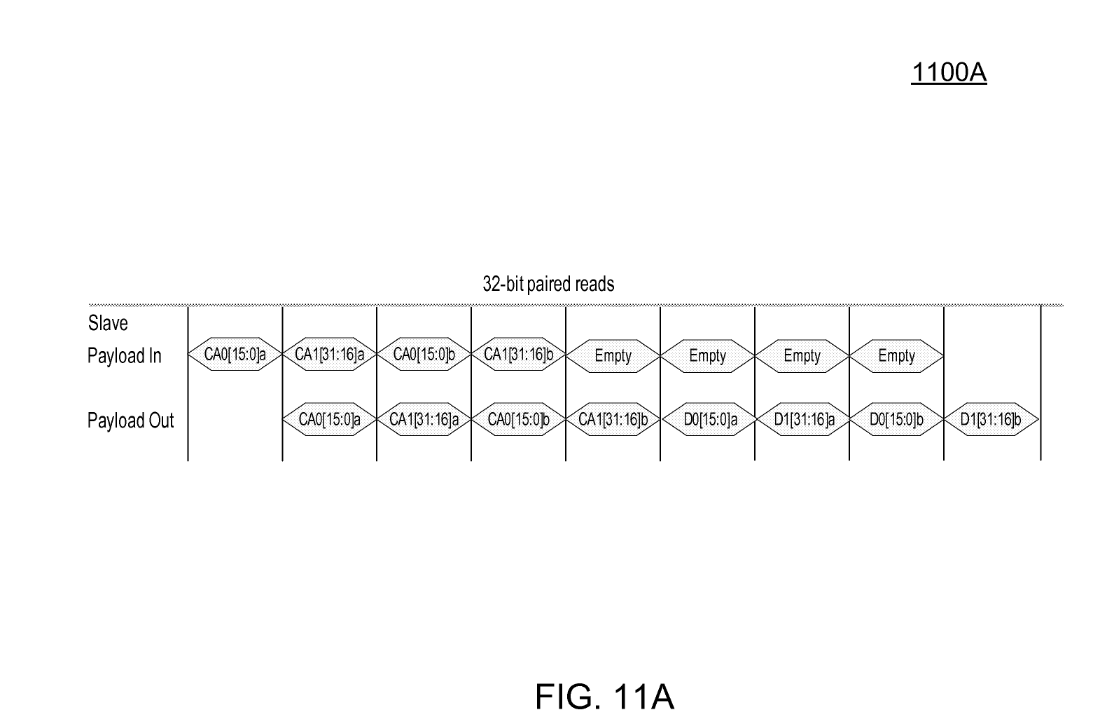

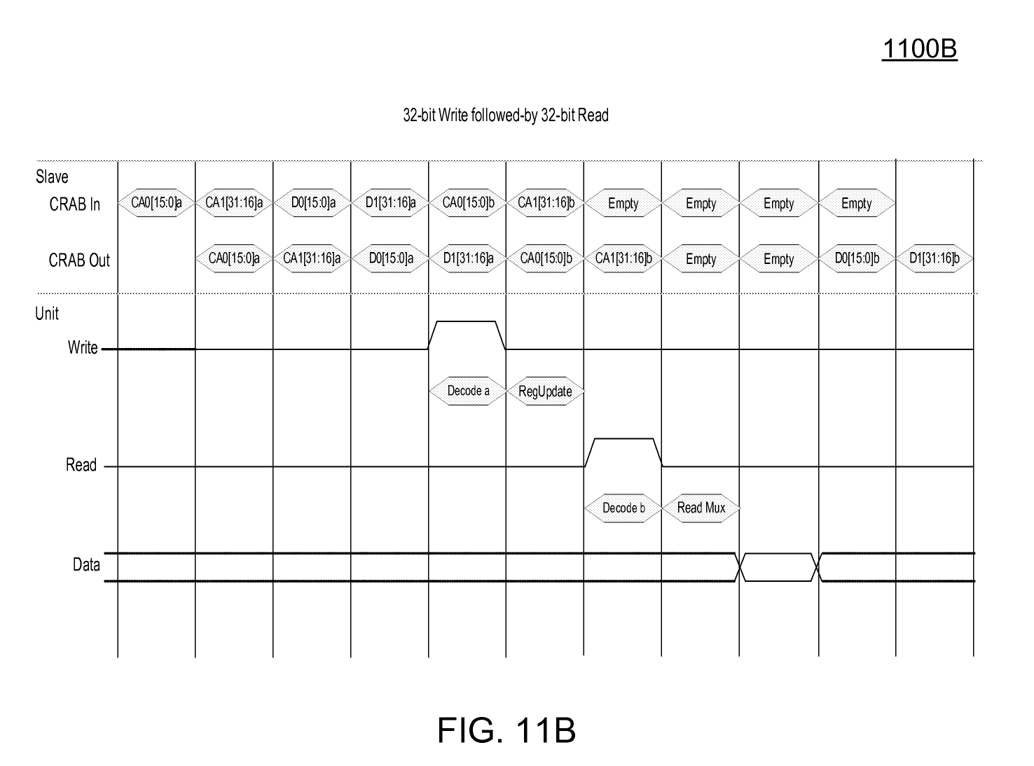

In order to improve throughput of the bus, there is a mechanism known as “paired READs”. The core-master is allowed to pair two 32 bit READs and send them interleaved on the bus to achieve maximum throughput. This is illustrated in FIG. 11A which is an illustration of a 32-bit paired READ pipeline, in accordance with one embodiment of the present disclosure. In FIG. 11A, the first transaction is known as “a” and the second as “b” (as appended to the end of each packet in the FIG. 11A).

The paired READ allows the core-master to schedule them as two normal 32 bit WRITEs after each other in corner cases. The core slave components are configured to handle the paired READ concept. Only 32 bit READs are paired together, in one implementation. It is considered acceptable that 64 bit reads do not fully utilize the bus cycles.

FIG. 11B is an illustration of a 32-bit WRITE followed by a 32-bit READ pipeline, in accordance with one embodiment of the present disclosure. In this case, from the perspective of a slave component when handling a WRITE followed by a READ to the same register, the slave needs to ensure that the READ returns the just written data. This is accomplished in FIG. 11B, where the READ is known as “a” and the WRITEs are known as “b”.

In one embodiment, CRAB does not support synchronous error signaling. In the case when the ROC root-master does detect an error (all errors cannot be detected) it will record the error and the address of the transaction and will also raise an interrupt. The response to the requesting agent (e.g. the core processing unit) will be all-F if the requesting agent expects a response (i.e. if it is a read). Note that all-F in itself is not an indication of an error (the core register could have contained that value) so this is just to ensure reproducible results.

Since CRAB address decoding is distributed across multiple agents, the address is partially decoded by CRAB-components and partially decoded by destination units. Therefore, a READ transaction to an invalid address can be handled by one of the following.

In one case, a READ transaction to a valid UnitID but unused register address-offset would result in all-0 response from control-register block. Note, this is not considered as invalid address. In another case, a READ transaction to a valid UnitID and valid register address-offset, but write-only register, would result in all-0 response from control-register block. Note, this is not considered as unused or invalid CRAB address. In still another case, a READ transaction to a valid CoreID but invalid CoreUnitID would result in all-F response from Core CRAB-Master. In another case, a READ transaction to an invalid ROC or CCLUSTER UnitID or to an invalid CoreID would result in ROC CRAB Master timeout. The response from the master will be all-F. The CRAB master will record an error along with address which caused the error condition and raise an MTS private interrupt. In still another case, if a READ transaction is issued to a (core, CCLUSTER or ROC) UnitID which is power-gated, then the CRAB-Bridge will immediately respond with all-F without forwarding the request. There is a bridge at each power-gating boundary. As such, the core-master will not record an error.

In the case of WRITEs to an invalid register address, posted writes do not return any response. As such, posted WRITEs to an invalid register-address will not be detected. Non-posted writes will fail to return an “acknowledgment” and the core-master will time-out for the same cases as a READ would have timed out. In another case, WRITEs to a valid UnitID, but unused register address-offset, are dropped on the floor by control-register block. In another case, WRITEs to valid UnitID and valid register address-offset, but read-only registers are dropped on the floor by control-register block. In still another case, WRITE transactions to invalid UnitID is dropped on the floor since no Unit will act on it. In another case, WRITE transactions to a (core, CCLUSTER or ROC) UnitID which is power-gated will be dropped by the bridge. In the case of a non-posted write, an “acknowledgment” will be returned immediately although the WRITE did not take effect. As such, the core-master will not record an error.

Thus, according to embodiments of the present disclosure, systems and methods are described for implementing a control register access bus configured in a hierarchical manner to provide low-cost, high throughput, power-efficient READ or WRITE accesses to register based resources of a SoC.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the present disclosure are thus described. While the present disclosure has been described in particular embodiments, it should be appreciated that the disclosure should not be construed as limited by such embodiments, but rather construed according to the below claims.

1. A communication system, comprising:
a communication bus;
one or more core units comprising one or more addressable core registers and coupled to said communication bus;
one or more core clusters (CCLUSTERs) coupled to said one or more core units through said communication bus, wherein said one or more CCLUSTERs provide one or more gateways for transactions to and from said one or more core units;
a request ordering and coherency (ROC) unit coupled to said one or more CCLUSTERs through said communication bus and for scheduling transactions relating to said registers onto said communication bus; and
one or more addressable registers, including said core registers, located in said ROC unit, said CCLUSTERs, and said one or more core units.

2. The communication system of claim 1, further comprising:
one or more masters located in said ROC unit and said one or more core units for scheduling and receiving transactions on said communication bus.

3. The communication system of claim 2, further comprising:
a root-master in said ROC unit, configured for handling transactions from outside sources and scheduling said transactions onto said communication bus.

4. The communication system of claim 2, further comprising
a core-master in one of said core units, configured for scheduling transactions onto a local ring bus coupling slaves components comprising registers.

5. The communication system of claim 4, wherein said core-master handles local requests for registers in said slave components.

6. The communication system of claim 1, further comprising:
one or more bridges for defining one or more branches of communication through said communication bus, wherein a bridge provides clock/power gating for underlying branches in said CCLUSTER and said core units; and
one or more splitters for internally splitting a corresponding branch of communication.

7. The communication system of claim 6, wherein a bridge filters requests based on core and CCLUSTER addressing.

8. The communication system of claim 6, wherein a bridge acts as a proxy for downstream units that are located on branches that have been powered off.

9. The communication system of claim 1, further comprising:
a multi-cast address addressing one or more core units including targeted registers.

10. A communication system, comprising:
a communication bus;
a core unit comprising one or more slave components including one or more registers, said core unit coupled to said communication bus, wherein said one or more slave components are configured in a ring topology, wherein each slave component provides a transaction interface to corresponding registers contained within; and
a core-master for scheduling transactions related to said registers onto said ring topology of said communication bus.

11. The communication system of claim 10, further comprising:
a first ring topology and a second ring topology each comprising unique groupings of said one or more slave components.

12. The communication system of claim 10, wherein said core-master handles local requests for registers in said slave components.

13. The communication system of claim 10, further comprising:
one or more core clusters (CCLUSTERs) coupled to said one or more core units through said communication bus, wherein said one or more CCLUSTERs provide one or more gateways for transactions to and from said one or more core units; and
a request ordering and coherency (ROC) unit coupled to said one or more CCLUSTERs for scheduling transactions relating to said registers onto said communication bus.

14. The communication system of claim 10, further comprising an integer execution units for tracking availability of said one or more registers, wherein said IEU interfaces with said core-master for scheduling said transactions based on said availability.

15. The communication system of claim 10, wherein each slave component acts as a ring repeater.

16. A method of communicating, comprising:
providing a communication bus;
coupling one or more core units comprising one or more addressable core registers onto said communication bus;
coupling one or more core clusters (CCLUSTERs) to said one or more core units through said communication bus, wherein said one or more CCLUSTERs provide one or more gateways for transactions to and from said one or more core units;
coupling a request ordering and coherency (ROC) unit to said one or more CCLUSTERs through said communication bus and for scheduling transactions relating to said registers onto said communication bus; and
providing a plurality of addressable registers accessible through said communication bus, wherein said addressable registers are located in said ROC unit, said CCLUSTERs, and said one or more core units, wherein said addressable registers include said core registers.

17. The method of claim 16, further comprising:
configuring a root-master in said ROC unit for receiving transactions from outside sources and scheduling said transactions onto said communication bus; and
configuring a core-master in one of said core units for scheduling transactions onto a local ring bus coupling slaves components comprising registers.

18. The method of claim 16, further comprising:
handling local requests for registers in said slave components using said core-master.

19. The method of claim 16, further comprising:
providing clock and/or power gating in one or more bridges, wherein said bridges define one or more branches of communication through said communication bus.

20. The method of claim 16, further comprising:
addressing one or more core units including targeted registers using a multi-cast address.
